(19) United States
(12) Patent Application Publication
(10) Pub. No.: US 2026/0237700 A1
(43) Pub. Date: Aug. 13, 2026

(54) METHOD FOR THE MODEL-BASED OPERATION OF A COOLANT SYSTEM, CONTROL UNIT, AND FUEL CELL SYSTEM

(71) Applicant: Robert Bosch GmbH, Stuttgart (DE)

(72) Inventors: Christian Dullinger, St. Pölten (AT); Alexander Metzger, Bad Vöslau (AT); Thomas Bleile, Stuttgart-Zuffenhausen (DE)

(21) Appl. No.: 19/156,787

(22) PCT Filed: Feb. 8, 2024
(86) PCT No.: PCT/EP2024/053144

§ 371 Date: Aug. 14, 2025

(30) Foreign Application Priority Data
Feb. 15, 2023 (DE) 10 2023 201 302.9

(51) Int. Cl. H01M 8/04992; H01M 8/04701

(52) U.S. Cl. CPC H01M 8/04992; H01M 8/04723

(57) ABSTRACT

The invention relates to a method for model-based operation, in particular control, of a controlled system (Σₚ(⋅)), preferably in the form of a subsystem of a coolant system (100), preferably for operating an electrochemical energy converter, comprising the following steps:
determining a control variable (y(k)) and from time derivatives (\dot{y}(k), ÿ(k), . . . , y^{(k)}) of the control variable (y(k)) up to a system order (n) of an augmented system model (Σ_{m,aug}(⋅)) of the controlled system (Σₚ(⋅)),
determining an actual manipulated variable (u_{act}(k)) of an actuator (Σₐ(⋅)) of the controlled system (Σₚ(⋅)),
providing a requested compensation term and/or correction term (d_{req}(k)) in dependence on the determination.

### BACKGROUND

The invention relates to a method for model-based operation, in particular control, of a controlled system, preferably in the form of a subsystem of a coolant system, preferably for operating an electrochemical energy converter, for example in the form of a fuel cell system or an electrolyzer. The invention also relates to a corresponding computer program product, a corresponding controller and a corresponding electrochemical energy converter.

Model-based control methods are generally known, e.g. as internal model controllers (IMC). An internal model controller according to prior art calculates/estimates a deviation term/error term (i.e., the model error or disturbance variable) as the difference between the output of the controlled system (i.e., the control variable) and the output of the system model. The deviation term/error term is usually used to compensate/correct the reference variable/target value accordingly. The correction is made at the entry point of the chain of effects. However, if the main model error (tolerance) is close to the output of the active chain (e.g. close to the manipulated variable), then the operating point of the model equations that lie between the input and the output of the active chain is not correct. This leads to an incorrect linearization of the model depending on the operating point. In such a case, poor control behavior (e.g.: oscillations) must therefore be expected.

### SUMMARY

The present invention provides: A method for model-based operation, in particular control, of a controlled system, preferably in the form of a subsystem of a coolant system, preferably for operating an electrochemical energy converter, for example in the form of a fuel cell system or an electrolyzer, with the features of the disclosure. In addition, the invention provides: A corresponding computer program, a corresponding controller, in particular in the form of an improved internal model controller (IMC), and a corresponding energy converter with the features of the disclosure. In this context, features and details described in connection with the various embodiments and/or aspects of the invention clearly also apply in connection with the other embodiments and/or aspects of the invention, and respectively vice versa, so, with respect to the disclosure, mutual reference to the individual embodiments and/or aspects of the invention is or can always be made.

The present invention provides, according to the first aspect: a method (hereinafter also referred to as a control method) for model-based operation, in particular control, of a controlled system, preferably in the form of a subsystem of a coolant system, preferably for operating an electrochemical energy converter, for example in the form of a fuel cell system or an electrolyzer.

The method comprises the following method steps/actions:
determining (e.g. measuring or observing) a control variable y(k) and time derivatives of the control variable \dot{y}(k), ÿ(k), . . . , y⁽ⁿ⁾ up to a system order n of a system model Σₘ(⋅) or an augmented system model Σ_{m,aug}(⋅) of the controlled system Σₚ(⋅),
determining (e.g. measuring or modeling and/or estimating) an actual manipulated variable of u_{act}(k) an actuator Σₐ(⋅) of the controlled system Σₚ(⋅),
providing a requested compensation term or correction term d_{req}(k) as a function of the determination (i.e. determination in the two previous steps of the method).

The steps of the method can be carried out simultaneously, successively and/or at least partially overlapping.

The method is used to propose a novel control method or control concept. The novel control method can improve control in an advantageous manner in the case of a nonlinear controlled system and/or a non-linear system model, in particular improving the control quality. The novel control method may advantageously include a flatness-based controller approach and include a feedforward part/functionality to follow a target value trajectory yₛₑₜ(k) for the controlled variable y(k).

The novel control method can make it possible in an advantageous way to directly address (i.e. estimate and correct) the largest uncertainties/inaccuracies of the model and/or unknown disturbance variables zᵤ(k). In other words, the model-based control method can enable the controller intervention to be provided by the requested compensation term/correction term d_{req}(k) precisely where the uncertainties/inaccuracies of the system model Σₘ(⋅) and/or the unknown disturbance variables zᵤ(k) are greatest, or the controller intervenes and compensates for these uncertainties/inaccuracies of the system model Σₘ(⋅) and/or the unknown disturbance variables zᵤ(k). In this way, the (implicit/intrinsic) operating point-dependent linearization achieved at the operating point of the non-linear controlled system and at the operating point of the non-linear system model can match, which can lead to a considerable increase in the robustness of the control method.

The augmented (possibly dynamic non-linear) system model Σ_{m,aug}(⋅) can be obtained by augmenting the (possibly dynamic non-linear) system model Σₘ(⋅) by introducing an additional deviation term or error term d(k) (e.g. in the form of an additive term, a multiplicative term, etc.) in one of the equations of the system model. Σₘ(⋅)

If an actuator Σₐ(⋅) (or a final control element) can provide information on its actual manipulated variable, then this information can be taken into account in the model-based control concept in an advantageous way. Furthermore, an intrinsic additional model Σ_{a,m}(⋅), which models the dynamic response behavior of the actuator Σₐ(⋅), can be used to determine an actual manipulated variable u_{act}(k).

The novel control method can make it possible in an advantageous way that the deviation term/error term d(k) can be estimated/calculated in almost every model equation of the system model Σₘ(⋅). The deviation term/error term d(k) can advantageously extend the system model Σₘ(⋅) as an internal model variable (e.g. as an additive term, a multiplicative term, etc.).

An actuator Σₐ(⋅) within the scope of the invention can, for example, have a pump, a valve, etc.

The novel control method can be used in an advantageous way with different controlled systems Σₚ(⋅) and/or different system models. Σₘ(⋅)

A coolant system can be understood as any temperature control system that uses a cooling fluid or coolant to enable the temperature control of an electrochemical energy converter, particularly in the form of a fuel cell stack of a fuel cell system or an electrolyzer.

The coolant may generally be referred to as a tempering agent.

In some modes of operation of the fuel cell system, such as for a freeze start and/or a cold start, the coolant system may serve to warm the fuel cell stack to appropriate operating temperatures. In turn, in other modes of operation of the fuel cell system, such as during normal operation, high-load operation, etc., the coolant system may serve to cool the fuel cell stack to appropriate operating temperatures.

A coolant system within the scope of the present disclosure may include a coolant pump for circulating the coolant. In addition, the coolant system may have a cooler bypass valve (a so-called mixing point of the coolant system, e.g. in the form of a three-way valve) to direct part of the coolant through the cooler (e.g. radiator) and/or another part past the cooler.

A controlled system Σₚ(⋅) of the coolant system can, for example, be a mixing point in which the coolant of the cooler path mixes with the coolant of the bypass path.

A controlled system Σₚ(⋅) of the coolant system can, for example, be a coolant path through a fuel cell stack of the fuel cell system.

A controlled system Σₚ(⋅) of the coolant system can, for example, be a coolant path through a cooler.

Furthermore, it can be provided that the controlled variable y(k) is determined as a measured controlled variable y_{measd}(k) or an observed controlled variable y_{obs}(k) (e.g. with the aid of an observer). Furthermore, it can be provided that at least one of the temporal derivatives \dot{y}(k), ÿ(k), . . . , y⁽ⁿ⁾ of the controlled variable y(k) is determined as a measured time derivative \dot{y}_{measd}(k), ÿ_{measd}(k), . . . ,

$${y}_{m e a s d}^{( n )} ( k )$$

of the controlled variable y(k) or an observed time derivative \dot{y}_{0bs}(k), ÿ_{obs}(k), . . . ,

$${y}_{o b s}^{( n )} ( k )$$

of the controlled variable y(k) (e.g. with the aid of an observer). is determined. This makes it possible to work either with the measured control variable y_{measd}(k) (or the measured value of the controlled variable y(k)) and its time derivatives \dot{y}_{measd}(k), ÿ_{measd}(k), . . . ,

$${y}_{m e a s d}^{( n )} ( k )$$

or with the observed controlled variable y_{obs}(k) (the observed value of the controlled variable y(k)) and its time derivatives \dot{y}_{0bs}(k), ÿ_{ob}s(k), . . . ,

$${y}_{o b s}^{( n )} ( k )$$

(e.g. determined by a special observer) in order to calculate, in particular, a deviation term or error term d(k). The observer Σ_{obs}(⋅) can receive the system model and possibly also a model of an actuator (i.e. a mathematical model of the actuator Σₐ(⋅)) and/or a model of a sensor (i.e. a mathematical model of the sensor Σₛ(⋅)). The time derivatives \dot{y}(k), ÿ(k), . . . , y⁽ⁿ⁾ of the controlled variable y(k) can also be calculated either by numerical differentiation of the measured controlled variable y_{measd}(k) or by using filters (e.g. DT1 filters). Sometimes, depending on the system, the time derivatives of the controlled variable can also be measured directly.

Furthermore, it can be provided that the actual manipulated variable u_{act}(k) is determined as a measured manipulated variable u_{measd}(k) or using an actuator model Σ_{a,m}(⋅) (i.e. a mathematical model that describes the dynamic response behavior from the requested manipulated variable u_{req}(k) to the actual real physical manipulated variable u(k) that acts on the controlled system Σₚ(⋅)). Advantageously, two fundamentally different ways of determining the actual manipulated variable u_{act}(k) can therefore be provided. These two fundamentally different options are described in more detail below.

Depending on the actuator (i.e., the controller) Σₐ(⋅), a measured manipulated variable u_{measd}(k) may be reported directly back from the actuator Σₐ(⋅). For example, it could be that a coolant pump measures its existing coolant mass flow directly. Or, depending on the actuator (i.e. the actuator) Σₐ(⋅), a measured manipulated variable u_{measd}(k) can possibly be determined indirectly from measured actuator information u_{measd,a}(k) (e.g. the actuator position, the actuator speed, etc.) using an actuator-specific software component. This means that the measured manipulated variable u_{measd}(k) can be provided directly to the augmented system model

$${\tilde{\sum }}_{m , a u g}^{- 1} ( \cdot )$$

whose equations are formulated (i.e. solved) such that the estimated deviation term/error term d(k) is calculated.

In the event that an actuator Σₐ(⋅) is not able to supply the measured manipulated variable u_{measd}(k) directly or indirectly, the actuator model Σ_{a,m}(⋅) described above can be taken into account to determine the actual manipulated variable. u_{act}(k) A mathematical model that models the dynamic response behavior of the actuator can thus be included in the novel control method presented. The actuator model Σ_{a,m}(⋅) can describe the (in particular dynamic) response behavior from the requested manipulated variable u_{req}(k) to the actual physical manipulated variable u(k) (i.e. the actually effective manipulated variable), which acts on the controlled system Σₚ(⋅). The “requested” manipulated variable from the previous time step u_{req}(k−1) (k is the time step) can be used as input for the actuator model Σ_{a,m}(⋅) which models the dynamic response behavior of the actuator. The so-called “actual” manipulated variable u_{act}(k) can then be set equal to the output signal of the actuator model Σ_{a,m}(⋅).

The advantages of a mathematical model that models the dynamic response behavior of the actuator can be explained using an example. In the example where the actuator Σₐ(⋅) is a coolant pump, the requested manipulated variable u_{req}(k) is the requested coolant mass flow to be provided by the coolant pump. The actual manipulated variable u_{act}(k) is the actual physically effective coolant mass flow that is currently being provided by the coolant pump. As the rotating parts of the coolant pump have a moment of inertia and the coolant also has to be accelerated, it takes a certain amount of time before the requested coolant mass flow is actually provided by the coolant pump. This can be represented in an advantageous way by the mathematical model of the coolant pump. A PT1 filter can serve as an example of a simple mathematical actuator model Σ_{a,m}(⋅).

The method also comprises:
determining a compensation term/correction term d_{req}(k) as the output of a filter Σ_{IMC}(⋅) (e.g.: a PT1 filter) whose input is the calculated/estimated deviation term/error term d(k),
wherein the parameters (e.g.: time constants, gain) of the filter Σ_{IMC}(⋅) influence the controller intervention and therefore represent the tuning parameters of the improved internal model controller (IMC), which must be set appropriately in order to achieve the desired control quality.

Furthermore, the method may also comprise:

Determining at least one, in particular calculated and/or measured, disturbance variable zₘ(k),
wherein the at least one, in particular calculated and/or measured, disturbance variable zₘ(k) is taken into account when providing a compensation term/correction term d_{req}(k). In this way, the requested manipulated variable u_{req}(k) can be calculated as a function of the compensation term/correction term d_{req}(k), the calculated and/or measured disturbance variables zₘ(k), the desired controlled variable y_{des}(k) (the desired value of the controlled variable y(k)) and its time derivatives \dot{y}_{des}(k), ÿ_{des}(k), . . . ,

$${y}_{d e s}^{( n )} ( k )$$

(up to the system order n of the augmented system model Σ_{m,aug}(⋅)). Advantageously, the largest uncertainties/inaccuracies of the system model Σₘ(⋅) and/or unknown disturbance variables zᵤ(k) can thus be addressed directly (i.e. calculated/estimated by the deviation term/error term d(k) and then corrected by the compensation term/correction term d_{req}(k)). In other words, the controller intervention (i.e. the requested compensation term/correction term d_{req}(k)) can be provided where the uncertainties/inaccuracies of the system model Σₘ(⋅) and/or the unknown disturbance variables zᵤ(k) are greatest in order to compensate for these uncertainties/inaccuracies and/or the unknown disturbance variables zᵤ(k) resulting in a robust control concept.

On the one hand, it is conceivable that the method is used to operate, in particular control, a controlled system Σₚ(⋅) in the form of a fuel cell stack. Preferably, a coolant outlet temperature from a fuel cell stack can be used as the controlled variable y(k), in particular to control a coolant differential temperature through a fuel cell stack.

It is also conceivable that the method is used to operate, in particular control, a controlled system Σₚ(⋅) in the form of a mixing point of a coolant system. Advantageously, a coolant inlet temperature in a fuel cell stack can be used as the controlled variable y(k).

It is also conceivable that the method is used to operate, in particular control, a controlled system Σₚ(⋅) in the form of a cooler (or generally a heat exchanger) of a coolant system. Advantageously, a coolant outlet temperature from a cooler can be used as the controlled variable y(k).

The method can therefore be used to enable advantageous model-based control of a coolant system, preferably for operating an electrochemical energy converter.

Furthermore, it can be advantageous that the method can be used for operating, in particular controlling, controlled systems with several input variables and/or several manipulated variables and/or several controlled variables.

According to a further aspect, the invention provides a computer program product comprising commands that, when executed by a computer, cause the computer to perform the method that can be carried out as described above. The computer program product may be used to achieve the same advantages described above in connection with the method according to the method. Full reference is made to these advantages in the present case.

A corresponding controller provides a further aspect of the invention. A computer program in the form of a code can be stored in a memory unit of the controller which, when the code is executed by a computing unit of the controller, carries out a procedure which can run as described above. With the aid of the controller, the same advantages may be achieved as described above in connection with the method according to the invention. Full reference is made to these advantages in the present case.

A corresponding electrochemical energy converter with a corresponding controller provides a further aspect of the invention. The energy converter can be used to achieve the same advantages as described above in connection with the method according to the invention. Full reference is made to these advantages in the present case.

### BRIEF DESCRIPTION OF THE DRAWINGS

### Preferred Exemplary Embodiments

The invention and the embodiments, as well as the advantages thereof, are explained in further detail hereinafter with reference to the drawing. It shows schematically in each case:

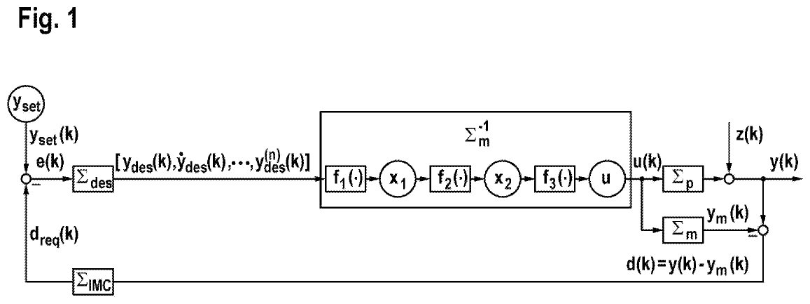

FIG. 1 a block diagram of an internal model controller (IMC) according to the prior art for a non-linear controlled system Σₚ(⋅) and a non-linear system model Σₘ(⋅) (the equations of which are formulated/solved herein as follows:

$$u = {\sum }_{m}^{- 1} ( {y}_{des} , {\dot{y}}_{d e s} , … , {y}_{d e s}^{( n )} ) )$$

with a flat output,

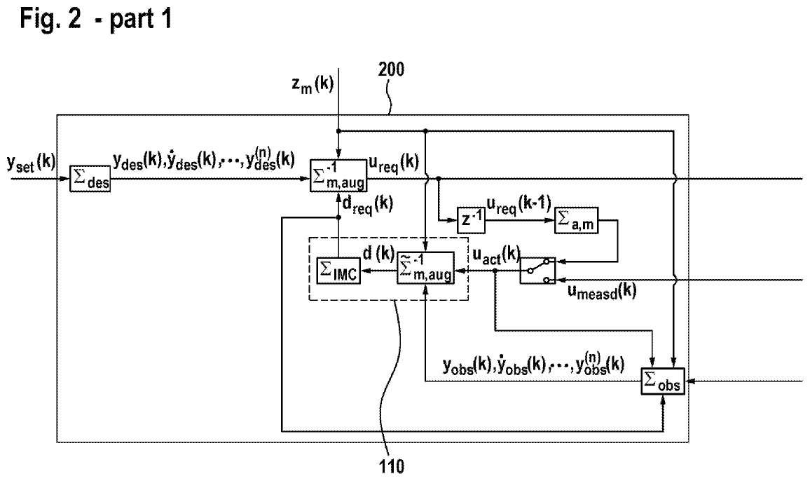

FIG. 2 a block diagram of a proposed novel non-linear flatness-based IMC control concept,

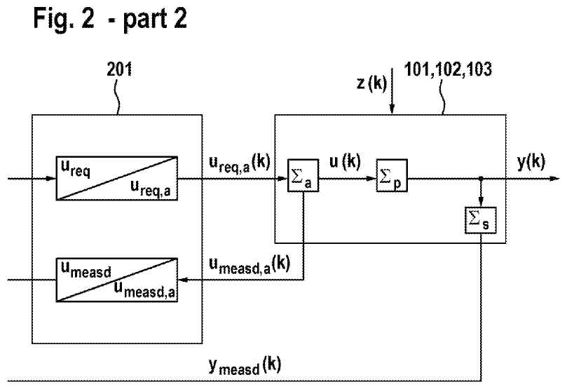

FIG. 3 an example of compensation/correction at a non-advantageous point in the active chain for the simple case of a static non-linear system model Σₘ(⋅) or a static non-linear controlled system Σₚ(⋅),

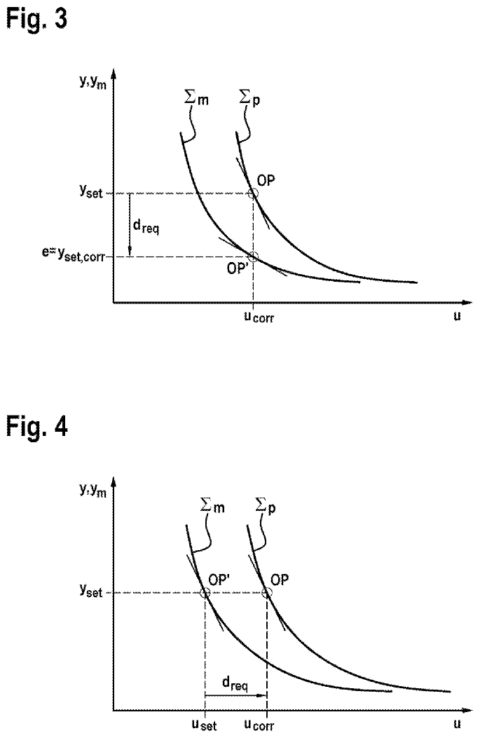

FIG. 4 an example of compensation/correction at an advantageous point in the active chain for the simple case of a static non-linear system model Σₘ(⋅) or a static non-linear controlled system Σₚ(⋅),

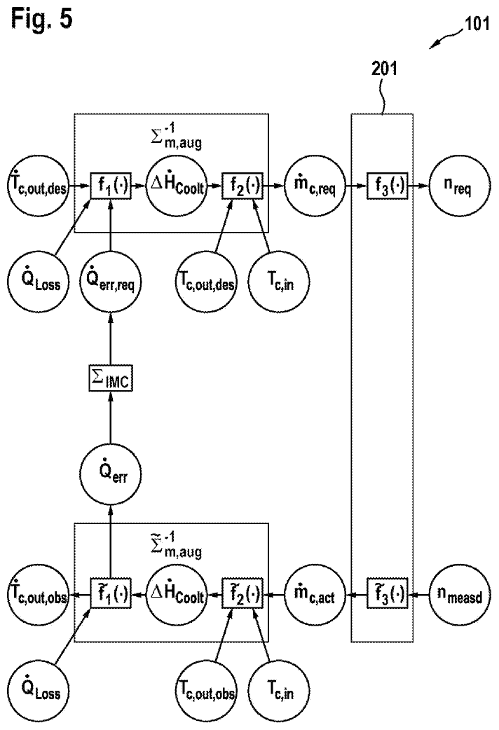

FIG. 5 schematic diagram of the active chain and a computer chain of the augmented system model Σ_{m,aug}(⋅) (once in the mathematical formulation

$${\sum }_{m , a u g}^{- 1} ( \cdot )$$

and once in the mathematical formulation

$${\tilde{\sum }}_{m , a u g}^{- 1} ( \cdot ) )$$

for the simplified application example: Control of the coolant outlet temperature of a fuel cell stack by means of a coolant mass flow delivered by the coolant pump

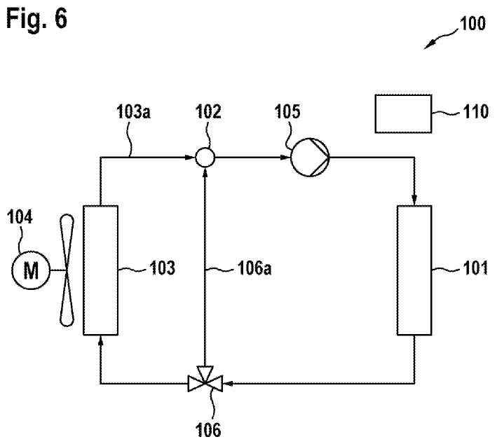

FIG. 6 an exemplary coolant system for a fuel cell system.

### DETAILED DESCRIPTION

In the blocks in FIGS. 1 to 5, “(⋅)” is omitted to save space (e.g. Σₚ(⋅) is abbreviated to Σₚ).

FIG. 1 shows the block diagram of an internal model controller (based on flatness) according to prior art for a non-linear controlled system Σₚ(⋅) and a non-linear system model Σₘ(⋅) with a flat output y(k), including insight into the effective chain (i.e., the calculation sequence y_{des}, . . . ,

$${y}_{d e s}^{( n )} \to {f}_{1} ( \cdot ) \to {x}_{1} \to {f}_{2} ( \cdot ) \to … \to u )$$

of the inverted model

$${\sum }_{m}^{- 1} ( \cdot ) .$$

If the largest model error (i.e. the model uncertainty/model inaccuracy) is close to the output of the active chain (e.g. the largest model error is assumed in equation f₃(⋅)), then the operating points of the model equations that lie between the input and the output of the active chain (i.e. f₁(⋅), f₂(⋅) and f₃(⋅)) are incorrect, which leads to an incorrect operating point-dependent linearization of the model. This means that poor control behavior (e.g. oscillations of the controlled variable y) must be expected.

FIG. 2 serves to explain a proposed method. The method (also referred to as a control method) was developed for model-based operation, in particular control, of a controlled system Σₚ(⋅), preferably in the form of a subsystem of a coolant system 100, preferably for operating an electrochemical energy converter 101, for example in the form of a fuel cell system or an electrolyzer. An exemplary coolant system 100 for a fuel cell system with a fuel cell stack 101 is shown in FIG. 6.

The method comprises the following method steps/actions:
determining (e.g. measuring or observing) a controlled variable y(k) and time derivatives \dot{y}(k), ÿ(k), . . . , y⁽ⁿ⁾(k) of the controlled variable y(k) up to a system order n of an augmented system model Σ_{m,aug}(⋅) of the controlled system Σₚ(⋅),
determining (e.g. measuring or modeling and/or estimating) an actual manipulated variable of u_{act}(k) an actuator of the controlled system Σₚ(⋅),
providing a controller intervention (i.e. the requested compensation term/correction term d_{req}(k)) as a function of the determination (i.e. determination in the two previous steps of the method).

The steps of the method can be carried out simultaneously, successively and/or at least partially overlapping.

The method can be used to provide a novel control method or control concept 200. The novel control method can advantageously make the control more robust in the case of a non-linear controlled system Σₚ(⋅) and/or a non-linear system model. Σₘ(⋅) As indicated in FIG. 2, the novel control method may advantageously include a flatness-based controller approach and include a feedforward part/functionality to follow a target value trajectory yₛₑₜ(k) for the controlled variable y(k).

As further indicated in FIG. 2, the novel control method can advantageously enable the largest uncertainties/inaccuracies of the system model Σₘ(⋅) and/or unknown disturbance variables zᵤ(k) to be calculated/estimated directly by the deviation term/error term d(k) and then corrected by the compensation term/correction term d_{req}(k). A controller 110 (see FIG. 2) can intervene precisely where the uncertainties/inaccuracies of the system model Σₘ(⋅) and/or the unknown disturbance variables zᵤ(k) are greatest (in particular with the aid of a requested compensation term/correction term d_{req}(k)) and compensate for these uncertainties/inaccuracies of the system model Σₘ(⋅) and/or the unknown disturbance variables zᵤ(k).

As indicated in FIG. 4, the (implicit/intrinsic) operating point-dependent linearization achieved at the operating point OP of the non-linear controlled system Σₚ(⋅) and at the operating point OP′ of the non-linear system model Σₘ(⋅) can match, which can lead to a considerable increase in the robustness of the control concept 200.

As illustrated in FIG. 2, if an actuator (i.e. a final control element) can provide measured values u_{measd,a}(k) for determining its actual manipulated variable u_{act}(k) then these measured values u_{measd,a}(k) can be taken into account in the model-based control concept 200 in an advantageous manner.

Furthermore, FIG. 2 illustrates that an intrinsic additional actuator model Σ_{a,m}(⋅) can be used to determine an actual manipulated variable u_{act}(k).

The novel control concept 200 can make it possible in an advantageous way that the deviation term/error term d(k) can be estimated/calculated in almost every model equation of the system model Σₘ (⋅). The deviation term/error term d(k) can be defined in an advantageous way, e.g. as an internal model variable (e.g. as an additive term, a multiplicative term, etc.) in one of the equations of the line model Σₘ(⋅) and extend the system model Σₘ(⋅) to the so-called augmented system model Σ_{m,aug}(⋅).

The compensation term/correction term d_{req}(k) (i.e. the controller intervention) can be used as the output of a filter Σ_{IMC}(⋅) (e.g.: a PT1 filter) whose input is the calculated/estimated deviation term/error term d(k), whereby the parameters (e.g.: time constants, gain) of the filter Σ_{IMC}(⋅) influence the controller intervention and therefore represent the tuning parameters of the improved internal model controller (IMC), which must be set appropriately in order to achieve the desired control quality.

An actuator within the scope of the invention may comprise, for example, a coolant pump 105, a valve 106 (e.g. a three-way valve), etc.

The novel control concept 200 can be used in an advantageous way with different controlled systems Σₚ(⋅) and/or different system models Σₘ(⋅).

The novel control concept 200 can be used in an advantageous manner with different controlled systems Σₚ(⋅) and/or different system models Σₘ(⋅) which can be used with several input variables and/or several manipulated variables u(k) and/or with several controlled variables y(k).

A coolant system 100 can basically be any temperature control system. An exemplary coolant system 100 is shown in FIG. 6, which can be used to control the temperature of a fuel cell stack 101 of a fuel cell system with the aid of a cooling fluid or coolant.

As shown in FIG. 6, the coolant system 100 can have a coolant pump 105 for circulating the coolant. In addition, the coolant system 100 may have a cooler bypass valve 106, for example in the form of a three-way valve, and a so-called mixing point 102 to direct the coolant in part through the cooler 103 (e.g. radiator) and/or in part past the cooler 103.

A controlled system Σₚ(⋅) of the coolant system 100 can, for example, be a mixing point 102, in which the coolant of the cooler path 103a mixes with the coolant of the bypass path 106a. A coolant inlet temperature in a fuel cell stack (101) can be used as the controlled variable y(k).

A controlled system Σₚ(⋅) of the coolant system 100 can, for example, be a coolant path through a fuel cell stack 101 of the fuel cell system. Preferably, a coolant outlet temperature Tc,out from a fuel cell stack 101 can be used as the controlled variable y(k) in particular to control a coolant differential temperature through a fuel cell stack 101.

A controlled system Σₚ(⋅) of the coolant system 100 can, for example, be a coolant path through a cooler 103. A coolant outlet temperature from a cooler 103 can be used as the controlled variable y(k).

FIG. 1 shows a block diagram of a known (flatness-based) internal model controller (IMC) for a non-linear controlled system Σₚ(⋅) and a non-linear system model Σₘ(⋅) with a flat output y(k). Here, the deviation term/error term d(k) is calculated as the difference between the output of the controlled system y(k) (i.e. the controlled variable) and the output of the system model yₘ(k)(i.e. d(k)=y(k)−yₘ(k)). As already mentioned, the basic idea of a known IMC is to estimate a deviation term/error term d(k) (i.e. the model error or the unknown disturbance variable(s) zᵤ(k)) and to compensate/correct the reference variable/target value yₛₑₜ(k) accordingly. As can be seen from FIG. 1, this compensation is carried out by subtracting the so-called requested correction term d_{req}(k) from the target value yₛₑₜ(k). The requested correction term d_{req}(k) is a filtered version of the estimated deviation term/error term d(k).

The block Σ_{des}(⋅) is a trajectory generator. The Σ_{IMC}(⋅) block is a filter whose parameters (e.g. time constants, gain) define the controller intervention.

The block

$${\sum }_{m}^{- 1} ( \cdot )$$

is the inverted non-linear system model Σₘ(⋅). The inverted system model

$${\sum }_{m}^{- 1} ( \cdot )$$

has a calculation sequence of (y_{des}, ÿ_{des}(k), . . .

$${y}_{des}^{( n )} )$$

to f₁(⋅) to x₁ to f₂(⋅) to x₂ to f₃(⋅) to u(k).

It should be noted that in the control method of the internal model controller according to the prior art, unlike in the invention proposed here, the system model Σₘ(⋅) is not augmented by a variable inserted in one of the equations of the system model Σₘ(⋅) (e.g. in the form of an additive term, a multiplicative term, etc.) to form the augmented system model Σ_{m,aug}(⋅).

The Σₚ(⋅) block is the non-linear controlled system.

If the largest model error (tolerance) is close to the output of the effect chain (e.g., the largest model error is assumed in equation f₃(⋅)), then the operating points of the model equations that lie between the input and output of the effect chain (i.e., f₁(⋅), f₂(⋅) und f₃(⋅)) are incorrect, which leads to incorrect operating point-dependent linearization of the model, as shown in FIG. 3 (however, for the simpler case of a statically non-linear controlled system Σₚ(⋅) or a static non-linear system model Σₘ(⋅) instead of a dynamically non-linear controlled system Σₚ(⋅) or a dynamic non-linear system model Σₘ(⋅)).

FIG. 3 shows the previously mentioned incorrect operating point-dependent linearization of the system model Σₘ(⋅). For the sake of simplicity, the case of a static (instead of a dynamic) non-linear model is considered. The fact that a static example is now considered in FIG. 3 and FIG. 4 instead of a dynamic example enables a clear two-dimensional representation of the relationship between u(k) and y(k) or yₘ(k) as a diagram. Compensation/correction d_{req}(k) is initiated at the input (i.e. the first variable) of the active chain. The corrected target value e(k)=y_{set,corr}(k) is determined by subtracting the “requested” correction term d_{req}(k) from the target value yₛₑₜ(k) (see also FIG. 1). As can be seen from FIG. 3, the gradient of the tangent at the operating point OP of the controlled system Σₚ(⋅) (the point where the target value yₛₑₜ(k) intersects the curve of the real non-linear controlled system Σₚ(⋅)) differs significantly from the gradient of the tangent at the operating point OP′ of the system model Σₘ(⋅) (the point where the corrected target value e(k)=y_{set,corr}(k) intersects the curve of the non-linear system model Σₘ(⋅)). Since the operating point-dependent linearization of the non-linear system model Σₘ(⋅), given by the gradient of the tangent in OP′, is clearly incorrect, poor control behaviors (e.g. oscillations) must be expected with FIG. 3.

FIG. 4 shows the following: Instead of initiating the compensation or correction at the input (i.e. the first variable) of the active chain as in FIGS. 1 and 3, in FIG. 4 the compensation or correction is performed at the output (i.e. the last variable) of the active chain, i.e. the manipulated variable u(k). Since in FIG. 4 the compensation or correction is carried out at the output (i.e, of the last variable) of the active chain, the manipulated variable uₛₑₜ(k) calculated by the inverted model

$${\sum }_{m}^{- 1} ( \cdot )$$

(note: augmenting the system model Σₘ(⋅) to the augmented system model Σ_{m,aug}(⋅) with an internal model variable is not necessary in this example), which is based on the target value yₛₑₜ(k), is corrected by the “requested” correction term d_{req}(k), resulting in a so-called corrected manipulated variable u_{corr}(k). The corrected manipulated variable u_{corr}(k) is then forwarded to the controlled system. As can be seen from FIG. 4, in this case the compensation or correction is carried out at the correct point in the active chain. correction is carried out at the correct point in the active chain, as the gradient of the tangent at the operating point OP of the controlled system Σₚ(⋅) (the point where the target value yₛₑₜ(k) intersects the curve of the real non-linear controlled system Σₚ(⋅)) is in this case almost identical to the gradient of the tangent at the operating point OP′ of the system model Σₘ(⋅) (the point where the target value yₛₑₜ(k) intersects the curve of the non-linear system model Σₘ(⋅)). Therefore, for this simple static example, initiating the compensation or correction d_{req}(k) at the output (i.e., the last variable) of the active chain (instead of initiating the compensation/correction d_{req}(k) at the input—i.e., the first variable—of the active chain, as is done in a prior art internal model controller control method, see FIGS. 1 and 3) is the better approach, as it leads to a suitable operating point-dependent linearization. The appropriate operating point-dependent linearization means that good control behavior can be expected here.

Instead of calculating the deviation term/error term d(k) as the difference between the output of the controlled system y(k) (i.e. the controlled variable) and the output of the system model yₘ(k), the present invention proposes to calculate it as an internal model variable.

In the case of a non-linear controlled system and a non-linear system model, this offers the degree of freedom to estimate/calculate the deviation term/error term d(k) at a point within the non-linear controlled system Σₚ(⋅) where the system model Σₘ(⋅) has a high model uncertainty/model inaccuracy.

The method can be used to achieve improved operating point-dependent linearization, which leads to a robust (internal model controller or IMC) control concept 200.

FIG. 2 shows the basic structure of the proposed novel non-linear flatness-based internal model controller (IMC) control concept 200. Although the proposed IMC control concept 200 can also be applied to multi-input multi-output (MIMO) systems, FIG. 2 shows only the single-input single-output (SISO) case for simplicity case (i.e., the manipulated variable u(k) and the control variable y(k) or its measured manipulated variable y_{measd}(k) are scalar signals and not vector signals, as would be the case in the MIMO case).

In FIG. 2, the block 101, 102, 103 represents the total controlled system or the real physical system. In this description, the term total controlled system is always used when the actuator (i.e. controller) Σₐ(⋅), the controlled system Σₚ(⋅) that is to be controlled and the sensor Σₛ(⋅) that supplies the measured controlled variable y_{measd}(k) are regarded as a single unit.

Depending on the type of actuator (i.e. positioner) or sensor (i.e. their response behavior) and the desired control quality, a model of the actuator and/or sensor may have to be taken into account in the control concept or can be neglected.

In reality, disturbance variables z(k) always have an effect on the controlled system Σₚ(⋅) and/or the overall controlled system. In principle, these disturbance variables z(k) always contain unknown disturbance variables zᵤ(k), but sometimes also calculable/measurable (and therefore known) disturbance variables zₘ(k). The calculable/measurable (and therefore known) disturbance variables zₘ(k) can be systematically taken into account in the new control method by feeding them as inputs into the blocks

$${\sum }_{m , aug}^{- 1} ( \cdot ) , {\tilde{\sum }}_{m , aug}^{- 1} ( \cdot ) and {\sum }_{obs} ( \cdot ) .$$

In the following, Σₚ(⋅) denotes the (possibly dynamic non-linear) controlled system (i.e. the real physical system, but without the actuator Σₐ(⋅) and without the sensor Σₛ(⋅)). Σₘ(⋅) denotes the (dynamic non-linear) system model (i.e. the mathematical model of the real physical system, but without the actuator Σₐ(⋅) and without the sensor Σₛ(⋅)).

Σ_{m,aug}(⋅) denotes the augmented (if necessary dynamic non-linear) system model, which is obtained by the (if necessary dynamic non-linear) system model Σₘ(⋅) by introducing an additional deviation term or error term d(k) (e.g., in the form of an additive term, a multiplier term, etc.) is Σₘ(⋅) augmented in one of the equations of the system model.

It should be noted that the controlled system Σₚ(⋅), the system model Σₘ(⋅) and the augmented system model Σ_{m,aug}(⋅) are generally represented/described by dynamic non-linear functions. The notation “(⋅)” is used to indicate that these non-linear functions depend on a plurality of input arguments, which are only mentioned for the sake of readability if this is necessary for understanding.

In the following, the notation Σ_{m,aug}(⋅) denotes the mathematical formulation of the (dynamic non-linear) augmented system model, which calculates the modeled controlled system output yₘ(k) (i.e., the value of the controlled variable y(k) calculated by the model) as a function of the manipulated variable u(k), the calculated and/or measured (and therefore known) disturbance variables zₘ(k) and the estimated deviation term/error term d(k), i.e.:

$${y}_{m} = {\sum }_{m , aug} ( u , {z}_{m} , d ) .$$

The notation

$${\sum }_{m , aug}^{- 1} ( \cdot )$$

denotes the formulation that calculates the manipulated variable u(k) as a function of the estimated deviation term/error term d(k), the calculated and/or measured (and therefore known) disturbance variables zₘ(k), the controlled variable y(k) and their time derivatives \dot{y}(k), ÿ(k), . . . , y⁽ⁿ⁾(k) (n is the system order of the system model Σₘ(⋅)), i.e.:

$$u = {\sum }_{m , aug}^{- 1} ( d , {z}_{m} , y , \dot{y} , … , {y}^{( n )} ) .$$

The notation

$${\tilde{\sum }}_{m , aug}^{- 1} ( \cdot )$$

denotes the formulation that calculates the estimated deviation term/error term d(k) as a function of the manipulated variable u(k), the calculated and/or measured (and therefore known) disturbance variables zₘ(k), the controlled variable y(k) and their time derivatives \dot{y}(k), ÿ(k), . . . , y⁽ⁿ⁾(k) (n is the system order of the system model Σₘ(⋅)), i.e.:

$$d = {\tilde{\sum }}_{m , aug}^{- 1} ( u , {z}_{m} , y , \dot{y} , … , {y}^{( n )} ) .$$

The reference numeral 201 stands for an actuator-specific software part.

FIG. 2 is described in detail below. The command signal/target value signal yₛₑₜ(k) goes into the trajectory generator Σ_{des}(⋅) (e.g. if the system order n of the system model is Σₘ(⋅) n=1, a PT1 filter can be used as a trajectory generator; if the system order n of the system model is Σₘ(⋅) n=0, a trajectory generator is not necessary and can therefore be omitted). The purpose of the trajectory generator Σ_{des}(⋅) is to calculate the so-called desired controlled variable y_{des}(k) (i.e. the desired value of the controlled variable y(k)) and the time derivatives \dot{y}_{des}(k), ÿ_{des}(k), . . . ,

$${y}_{des}^{( n )} ( k ) .$$

The desired controlled variable y_{des}(k) and its time derivatives \dot{y}_{des}(k), ÿ_{des}(k),

$${y}_{des}^{( n )} ( k )$$

are then entered into the

$${\sum }_{m , aug}^{- 1} ( \cdot )$$

model (instead of y(k), \dot{y}(k), ÿ(k), . . . , y⁽ⁿ⁾(k)). In addition, the calculated and/or measured (and therefore known) disturbance variables zₘ(k) are included in the model

$${\sum }_{m , aug}^{- 1} ( \cdot )$$

and instead of the estimated deviation term/error term d(k) a so-called requested compensation term/correction term d_{req}(k) is included in the model a

$${\sum }_{m , aug}^{- 1} ( \cdot ) .$$

The requested compensation term/correction term d_{req}(k) can be calculated using d_{req}(k)=Σ_{IMc}(d(k)). Consequently, the so-called requested manipulated variable u_{req}(k) is calculated:

$${u}_{eq} = {\sum }_{m , aug}^{- 1} ( {d}_{req} , {z}_{m} , {y}_{des} , {\dot{y}}_{des} , … , {y}_{des}^{( n )} ) .$$

The requested manipulated variable u_{req}(k) is then converted by an actuator-specific software part 201 to the control signal u_{req,a}(k) (e.g. a pulse-width modulated signal, etc.) required by the respective actuator Σₐ(⋅).

The block Σ_{IMC}(⋅) is a filter (e.g.: a PT1 filter) whose parameters (e.g.: time constants, gain) define the controller intervention and can therefore represent the tuning parameters of the IMC, which can be set appropriately to achieve the desired control quality. The estimated deviation term/error term d(k), which is the input of the block Σ_{IMC}(⋅), is calculated by

$${\tilde{\sum }}_{m , aug}^{- 1} ( \cdot ) .$$

For this purpose,

$${\tilde{\sum }}_{m , aug}^{- 1} ( \cdot ) .$$

(instead of y(k), \dot{y}(k), ÿ(k), . . . , y⁽ⁿ⁾(k)) is calculated either with the measured controlled variable y_{measd}(k) (the measured value of the controlled variable y(k)) and its time derivatives \dot{y}_{measd}(k), ÿ_{measd}(k), . . .

$${y}_{measd}^{( n )} ( k )$$

or with the observed controlled variable y_{obs}(k) (the observed value of the controlled variable y(k)) and its time derivatives \dot{y}_{0bs}(k), ÿ_{ob}s(k), . . . ,

$${y}_{obs}^{( n )} ( k ) ,$$

determined by a special observer Σ_{obs}(⋅).

The observer Σ_{obs}(⋅) contains the system model Σₘ(⋅) and possibly also a model of the actuator (i.e. a mathematical model of the actuator Σₐ(⋅)) and/or a model of the sensor (i.e. a mathematical model of the sensor Σₛ(⋅)).

The time derivatives \dot{y}_{measd}(k), ÿ_{measd}(k), . . . ,

$${y}_{measd}^{( n )} ( k )$$

can be calculated either by numerical differentiation of y_{measd}(k) or by using filters (e.g. DT1 filter). Depending on the system, the derivatives \dot{y}_{measd}(k), ÿ_{measd}(k), . . . ,

$${y}_{measd}^{( n )} ( k )$$

can also be measured directly.

In addition,

$${\tilde{\sum }}_{m , aug}^{- 1} ( \cdot )$$

(instead of u(k)) is fed with the so-called actual manipulated variable u_{act}(k). FIG. 2 shows two ways in which the actual manipulated variable u_{act}(k) can be obtained. If the actuator (i.e. the positioner) Σₐ(⋅) can provide feedback on the manipulated variable u(k) by means of the measured manipulated variable u_{measd}(k), the actual manipulated variable u_{act}(k) can be set equal to the measured manipulated variable u_{measd}(k) (i.e. u_{act}(k)=u_{measd}(k)) (the switch in FIG. 2 would be in the lower position in this case).

Depending on the actuator (i.e. the actuator) Σₐ(⋅) u_{measd}(k) “may be measured directly (For example, a coolant pump may directly measure its existing coolant mass flow) or calculated by an actuator-specific software part based on a measured actuator information u_{measd,a}(k) (e.g.: the actuator position, the actuator speed, etc.). For example, it could be that a coolant pump can provide information about its current speed (i.e. in this case u_{measd,a}(k) would be the current speed), which can be used to calculate the current coolant mass flow provided by the coolant pump. At this point, it should be noted that this document does not go into detail about the actuator-specific software part.

However, in the event that an actuator (i.e. an actuator) Σₐ(⋅) is not able to supply u_{measd}(k) or u_{measd,a}(k) (in this case, the switch in FIG. 2 would be in the upper position as shown), the proposed novel non-linear flatness-based IMC control concept 200 provides a solution.

The following describes how to proceed if the specific actuator (i.e. controller) Σₐ(⋅) is not able to provide u_{measd}(k) or u_{measd,a}(k).

A mathematical modelΣ_{a,m}(⋅), which models the dynamic response behavior of the actuator, is included in the novel non-linear flatness-based IMC control concept 200 (see FIG. 2). The model Σ_{a,m}(⋅) describes the (dynamic) response behavior of the requested manipulated variable u_{req}(k) to the actual physical manipulated variable u(k) (i.e. the actual effective manipulated variable) which acts on the controlled system Σₚ(⋅). In order to avoid an algebraic loop within the software in which the novel control method or control concept 200 can be implemented, the requested manipulated variable u_{req}(k) is sometimes fed into a dead time block (the block z⁻¹ in FIG. 2)), which supplies the requested manipulated variable u_{req}(k−1) from the previous time step (k−1). The variable k denotes the time slice. As can be seen in FIG. 2, the requested manipulated variable from the previous time step u_{req}(k−1) is then fed as an input into the block Σ_{a,m}(⋅), which models the dynamic response behavior of the actuator. The so-called actual manipulated variable u_{act}(k) is then set equal to the output signal of the Σ_{a,m}(⋅) block, i.e.:

$${u}_{act} ( k ) = {\sum }_{a , m} ( {u}_{req} ( k - 1 ) ) .$$

The advantages of incorporating a mathematical model Σ_{a,m}(⋅) that models the dynamic response behavior of the actuator are explained below as an example. In the case where the actuator is a coolant pump 105, u_{req}(k) is the requested coolant mass flow to be provided by the coolant pump 105 and u(k) is the actual physical effective coolant mass flow currently being provided by the coolant pump. Since the rotating parts of the coolant pump 105 have a moment of inertia and the coolant also has to be accelerated, it takes a certain amount of time until the “requested” coolant mass flow u_{req}(k) can actually be provided by the coolant pump 105. This fact can be represented by the mathematical model Σ_{a,m}(⋅). In this case, a PT1 filter can be used as a simple Σ_{a,m}(⋅) model that models the dynamic response behavior of the actuator.

FIG. 5 shows a schematic sketch of the active chain (i.e. the calculation chain) of the augmented (dynamic non-linear) system model Σ_{m,aug}(⋅)(once in the mathematical formulation

$${\tilde{\sum }}_{m , aug}^{- 1} ( \cdot )$$

and once in the mathematical formulation

$${\tilde{\sum }}_{m , aug}^{- 1} ( \cdot ) .$$

FIG. 5 indicates where an estimated deviation term/error term d(k) can be expressed and calculated by

$${\tilde{\sum }}_{m , aug}^{- 1} ( \cdot )$$

or where the requested compensation term/correction term d_{req}(k) can be introduced as an input into the block

$${\tilde{\sum }}_{m , aug}^{- 1} ( \cdot ) .$$

As an example, the active chain (i.e., the calculation chain) of the (simplified) thermal system model Σₘ(⋅) of a fuel cell stack 101, whose coolant outlet temperature is to be controlled by the coolant mass flow delivered by the coolant pump 105, is presented in FIG. 5.

In FIG. 5, the variables in the circles (e.g.: Δ\dot{H}_{Coolt}(k), \dot{m}_{c,req}, \dot{m}_{c,act}, etc.) are variables and the values in the small rectangles (e.g.: f₁(⋅), f₂(⋅), etc.) are mathematical equations. T_{c,out,des} is the desired coolant outlet temperature of the fuel cell stack 101. \dot{T}_{c,out,des} is the first time derivative of the desired coolant outlet temperature of the fuel cell stack 101. \dot{Q}_{Loss} is the electrical losses that are dissipated as heat within the fuel cell stack 101. T_{c,in} is the actual coolant inlet temperature of the fuel cell stack 101. Δ\dot{H}_{Coolt} is the differential enthalpy flow between the coolant inlet and coolant outlet of the fuel cell stack 101. \dot{m}_{c,req} is the requested coolant mass flow through the fuel cell stack 101 (corresponds to the requested manipulated variable u_{req}(k) in FIG. 2). \dot{m}_{c,act} is the actual coolant mass flow through the fuel cell stack 101 (corresponds to the actual manipulated variable u_{act}(k) in FIG. 2). n_{req} is the requested speed of the coolant pump 105 (corresponds to u_{req,a}(k) in FIG. 2). n_{measd} is the measured speed of the coolant pump 105 (corresponds to u_{measd,a}(k) in FIG. 2). \dot{Q}ₑᵣᵣ is the estimated heat flow error (corresponds to the estimated deviation term/error term d(k) in FIG. 2). \dot{Q}_{err,req} is the requested heat flow error (corresponds to the requested compensation term/correction term d_{req}(k) in FIG. 2). T_{c,out,obs} is the observed coolant outlet temperature of the fuel cell stack 101 (corresponds to the observed controlled variable y_{obs}(k) in FIG. 2). \dot{T}_{c,out,obs} is the observed first time derivative of the coolant outlet temperature of the fuel cell stack 101 (corresponds to \dot{y}_{0bs}(k) in FIG. 2).

A corresponding computer program, a corresponding controller 110, in particular in the form of an improved internal model controller (IMC), and a corresponding energy converter (not shown in its entirety for reasons of simplicity only) also represent aspects of the invention.

The preceding description of the embodiments describes the present invention exclusively in the context of examples. Of course, individual features of the embodiments can be freely combined with one another, provided that this is technically meaningful, without departing from the scope of the present invention.

1. A method for model-based operation of a controlled system (Σₚ(⋅)),
the method comprising:
determining a control variable (y(k)) and from time derivatives (\dot{y}(k), ÿ(k), . . . , y⁽ⁿ⁾) of the control variable (y(k)) up to a system order (n) of an augmented system model (Σ_{m,aug}(⋅)) of the controlled system (Σₚ(⋅)),
determining an actual manipulated variable (u_{act}(k)) of an actuator (Σₐ(⋅)) of the controlled system (Σₚ(⋅)), and
providing a requested compensation term and/or correction term (d_{req}(k)) in dependence on the determination.

2. The method according to claim 1,
wherein
the control variable (y(k)) is determined as a measured controlled variable (y_{measd}(k)) or an observed control variable (y_{obs}(k)),
and/or that at least one of the time derivatives (\dot{y}(k), ÿ(k), . . . , y⁽ⁿ⁾) of the control variable (y(k)) is a measured time derivative (\dot{y}_{measd}(k), ÿ_{measd}(k), . . . ,
$${y}_{measd}^{( n )} ( k ) )$$
of the controlled variable (y(k)) or an observed time derivative (\dot{y}_{obs}(k), ÿ_{obs}(k), . . . ,
$${y}_{obs}^{( n )} ( k ) )$$
of the control variable (y(k)).

3. The method according to claim 1,
wherein
the actual manipulated variable (u_{act}(k)) is determined as a manipulated variable (u_{measd}(k)) measured indirectly via an actuator information (u_{measd,a}(k)) or directly or using a model (Σ_{a,m}(⋅)) that models dynamic response behavior of the actuator (Σₐ(⋅)).

4. The method according to claim 1,
wherein
the augmented system model (Σ_{m,aug}(⋅)) is obtained by augmenting the system model (Σₘ(⋅)) of the controlled system (Σₚ(⋅)) in a model equation that models a physical power balance.

5. The method according to claim 1,
wherein
that the method further comprises:
determining at least one disturbance variable (zₘ(k)),
wherein at least one calculated and/or measured disturbance variable (zₘ(k)) is taken into account when providing a requested compensation term and/or correction term (d_{req}(k)).

6. The method according to claim 1,
wherein
the method controls a controlled system (Σₚ(⋅)) in the form of a fuel cell stack (101),
and/or that a coolant outlet temperature from a fuel cell stack (101) is used as the control variable (y(k)),
to control a coolant differential temperature through a fuel cell stack (101).

7. The method according to claim 1,
wherein
the method is used for controlling a controlled system (Σₚ(⋅)) in the form of a mixing point (102) of a coolant system (100),
and/or that a coolant inlet temperature into a fuel cell stack (101) is used as the control variable (y(k)).

8. The method according to claim 1,
wherein
the method is used for controlling a controlled system (Σₚ(⋅)) in the form of a cooler (103) of a coolant system (100),
and/or that a coolant outlet temperature from a cooler (103) is used as the control variable (y(k)).

9. The method according to claim 1,
wherein
the method is used for controlling; controlled systems (Σₚ(⋅)) with several input variables and/or several manipulated variables and/or several output variables and/or with several control variables.

10. A non-transitory, computer-readable medium comprising instructions which, when executed by a computer, cause the computer to control model-based operation of a controlled subsystem of a coolant system (Σₚ(⋅)) by:
determining a control variable (y(k)) and from time derivatives (\dot{y}(k), ÿ(k), . . . , y⁽ⁿ⁾) of the control variable (y(k)) up to a system order (n) of an augmented system model (Σ_{m,aug} (⋅)) of the controlled system Σₚ(⋅)), determining an actual manipulated variable (u_{act}(k)) of an actuator (Σₐ(⋅)) of the controlled system Σₚ(⋅)), and
providing a requested compensation term and/or correction term (d_{req}(k)) in dependence on the determination.

11. A controller (110), comprising a memory in which a code is stored, and a computer, wherein when the code is executed by the computer to control model-based operation of a controlled subsystem of a coolant system (Σₚ(⋅) by:
determining a control variable (y(k)) and from time derivatives (\dot{y}(k), ÿ(k), . . . , y⁽ⁿ⁾) of the control variable (y(k)) up to a system order (n) of an augmented system model (Σ_{m,aug}(⋅)) of the controlled system (Σₚ(⋅))
determining an actual manipulated variable (u_{act}(k)) of an actuator (Σₐ(⋅)) of the controlled system (Σₚ(⋅)), and
providing a requested compensation term and/or correction term (d_{req}(k)) in dependence on the determination.

12. An electrochemical energy converter comprising a controller (110) according to claim 11.
